(19) United States
(12) Patent Application Publication
(10) Pub. No.: US 2024/0308438 A1
(43) Pub. Date: Sep. 19, 2024

(54) HOLDING SYSTEM AND METHOD FOR RELEASABLY ATTACHING A FLAT ITEM TO AN OBJECT AND HOLDING DEVICE FOR USE IN SUCH A HOLDING SYSTEM

(71) Applicant: Garrit KELLER, Berlin (DE)

(72) Inventor: Garrit KELLER, Berlin (DE)

(21) Appl. No.: 18/406,553

(22) Filed: Jan. 8, 2024

(30) Foreign Application Priority Data
Mar. 13, 2023 (DE) 10 2023 106 225.5

(51) Int. Cl. B60R 11/02; F16M 11/04; F16M 13/02

(52) U.S. Cl. CPC B60R 11/0241; F16M 11/041; F16M 13/022

(57) ABSTRACT

A holding system (10) for releasable attachment of a flat item (12) to an object (14) includes a receiving structure (16) is associated with the flat item (12) or the object (14) and a retaining structure (18) is associated with the other one. The structures (16, 18) engage with each other. The retaining structure (18) includes two latching elements (20, 22) arranged in opposite directions and movable relative to one another and have latching sections (24) which engage in corresponding receiving sections (26; 26′) of the receiving structure (16). The latching elements (20, 22) are movable relative to one another so that a distance (a1) between the latching sections (24) can be changed to switch the retaining structure (18) between a release position and a latching position. The retaining structure (18) has a base body (30) and only one latching element (20) is movably guided in respect to the base body (30). Another latching element (22) arranged opposite the movable latching element (20) is fixed immovably to the base body (30) or forms an integral part of the base body (30).

### BACKGROUND OF THE INVENTION

### 1. Field of Invention

The present invention relates to a holding system for releasable attachment of a flat item to an object. A receiving structure is associated with one of the flat item and the object, and a retaining structure is associated with the other one of the flat item and the object. The two structures can engage with each other for releasably attaching the flat item to the object. The retaining structure has at least two latching elements which are arranged opposite one another and are movable relative to one another and which have latching sections which are designed to engage with corresponding receiving sections of the receiving structure. The oppositely arranged latching elements are movable relative to one another in such a way that a distance between the latching sections is variable in order to switch the retaining structure between a release position, in which the retaining structure can be inserted into or removed from the receiving structure, and a latching position, in which the retaining structure is latched to the receiving structure.

The invention also relates to a holding device for use in such a holding system. The holding device represents an object to which a flat item can be releasably attached. The holding device comprises a retaining structure which can engage with a receiving structure associated with the flat item for releasable attachment thereto. The retaining structure has at least two latching elements which are arranged opposite one another and are movable relative to one another and which have latching sections which are designed to engage with corresponding receiving sections of the receiving structure. The oppositely arranged latching elements are movable relative to one another in such a way that they (or their respective latching sections) are at a greater distance in respect to each other in a latching position of the retaining structure than in a release position of the retaining structure. The retaining structure can be inserted into the receiving structure or removed therefrom in the release position, and latched to the receiving structure in the latching position.

Finally, the present invention also relates to a method for releasably attaching a flat item to an object, wherein one of the two, the item or the object, is assigned a receiving structure and the other of the two is assigned a retaining structure, which can engage with one another for releasably attaching the flat item to the object. The retaining structure has at least two latching elements which are arranged opposite to one another and movable relative to one another and which have latching sections which are designed to engage with corresponding receiving sections of the receiving structure. The oppositely arranged latching elements are movable relative to one another in such a way that they (or their respective latching sections) are at a greater distance in respect to each other in a latching position of the retaining structure than in a release position of the retaining structure. The retaining structure can be inserted into the receiving structure or removed therefrom in the release position, and latched to the receiving structure in the latching position.

### DESCRIPTION OF RELATED ART

Holding systems of the type mentioned above are known from the state of the art in various embodiments. The various systems differ essentially in whether the movable latching elements are moved rotationally or linearly between the release position of the retaining structure and the latching position of the retaining structure. Systems in which the latching elements perform a rotational movement are, for example, the systems from QuadLock (see e.g., U.S. Pat. No. 8,830,663 B2 and U.S. Pat. No. 9,243,739 B2) and SP Connect (see e.g., EP 3 391 631 A1). EP 4 101 701 A1 also describes such a rotary system. The problem with rotary systems is the space required to rotate the flat item (e.g., an electrical end user device) placed on the holding device in the release position by 45° or 90° in order to move the retaining structure from the release position to the latching position and to secure the end user device to the holding device.

Holding systems with linearly movable latching elements are known, for example, from Mous (“Intralock”, see e.g., WO 2021/044 149 A1) and from PeakDesign (“SlimLink”, see e.g., US 2023/054 404 A1). In the holding system from PeakDesign, the holding device comprises a rectangular, flat support surface for holding the rear side of a mobile end user device, on which support surface a raised retaining structure is formed approximately in the middle. The retaining structure has at least two latching elements which are arranged opposite to one another and movable which have latching sections which can engage with corresponding receiving sections of a receiving structure on the rear side of the mobile end user device. The latching elements, which can move in opposite directions relative to one another, (or their respective latching sections) are at a greater distance from one another in a latching position of the retaining structure than in a release position of the retaining structure. The retaining structure can be inserted into the receiving structure or removed therefrom in the release position, and latched to the receiving structure in the latching position.

Actuation buttons are arranged on opposite sides of a base body of the retaining structure to actuate the latching elements. The user must hold down at least one of the buttons with the thumb and/or index finger of one hand to bring the retaining structure into the release position, while gripping the flat item, e.g., a mobile end user device, with the other hand. This makes the operation of the known holding system, in particular the removal of the flat item from the holding device, very cumbersome and time-consuming.

Furthermore, in the known holding system, the entire raised retaining structure enters a corresponding recess in the receiving structure when the retaining structure is in the release position. If the retaining structure or the recess in the receiving structure becomes dirty, this can lead to considerably more difficult operation or even damage to the holding system.

Finally, the retaining structure of the known holding system has relatively many parts, is complex in design and construction and is quite delicate. In order to achieve the required robustness, many parts of the retaining structure must be made of metal. In the known holding system, the latching elements not only move towards or away from each other during their linear movement (parallel to the surface extension of the flat support surface of the holding device), but when moving towards each other, they also enter into the holding device transversely or at an angle to the surface extension of the flat support surface, so that they are arranged below the support surface. This is achieved by the latching elements being mounted on an axis and rotating radially inwards and into the housing via this axis in order to move the retaining structure into the release position.

Based on the described prior art, it is an object of the present invention to provide for a linear holding system that is particularly easy and quick to operate and use and has a particularly robust design.

### SUMMARY OF THE INVENTION

To solve this object, a holding system with the features of claim 1 is proposed. In particular, based on the holding system of the type mentioned above, it is proposed that
the retaining structure has a base body and
only at least one first latching element of the latching elements is movably guided in respect to the base body, whereas at least one other latching element of the latching elements arranged opposite the at least one first movable latching element is fixed immovably to the base body or forms an integral part of the base body, i.e., is formed integrally as a single part therewith.

For better understanding, hereinafter only a movable first latching element and a fixed, immovable other or second latching element are referred to. However, it is understood that this always refers to at least one movable first latching element or at least one stationary, immovable other or second latching element.

According to an advantageous further embodiment of the invention, it is proposed that the first movable latching element is guided in respect to the base body so as to be linearly movable between an extended position, in which the retaining structure is in the latching position, and a retracted position, in which the retaining structure is in the release position. In a first preferred embodiment, it is suggested that the latching sections are formed facing away from each other on the latching elements. Accordingly, the receiving sections of the receiving structure are formed or arranged facing each other. In the latching position of the retaining structure, the movable first latching element is moved radially outwards away from the stationary other latching element. Accordingly, in the release position of the retaining structure, the first latching element is moved radially inwards towards the other latching element. In the release position, the latching sections can be inserted into the receiving structure and positioned radially inside or in front of the corresponding receiving sections. When the retaining structure is moved into the latching position, the first latching element is moved radially outwards so that its latching section enters into the corresponding receiving section from the inside. A further movement of the movable first latching element then causes a relative movement between the receiving structure and the retaining structure, so that the fixed other latching element also enters from the inside into a corresponding receiving section. The retaining structure and the receiving structure are now locked together.

According to an alternative embodiment, however, it would also be possible for the latching sections to be located facing each other on the latching elements. Accordingly, the receiving sections of the receiving structure would be formed or arranged facing away from each other. In the latching position of the retaining structure, the movable first latching element would be moved radially inwards towards the stationary other latching element. Accordingly, in the release position of the retaining structure, the first latching element would be moved radially outwards away from the other latching element. In the release position, the latching sections could be inserted into the receiving structure and positioned radially outside or in front of the corresponding receiving sections. When the retaining structure is moved into the latching position, the first latching element would be moved radially inwards so that its latching section would enter the corresponding receiving section from the outside. A further movement of the movable first latching element would then cause a relative movement between the receiving structure and the retaining structure, so that the fixed other latching element would also enter a corresponding receiving section from the outside. Now the retaining structure and the receiving structure would be locked together.

The movement distance covered by moving the movable first latching element from an extended to a retracted position is such that the retaining structure moves from the latching position to the release position, so that the retaining structure can be inserted into the receiving structure.

In the invention, the movement of the movable first latching element from the extended to the retracted position is effected in a particularly advantageous manner by the receiving structure being placed only on the movable first latching element, in particular together with the flat item attached thereto. After placing or inserting the receiving structure only onto or into the first latching element, the first latching element can be moved by applying force to the flat item on which the receiving structure is formed or arranged. In particular, the first latching element can be moved from an extended position to a retracted position in order to transfer the retaining structure from the latching position to the release position. In the retracted position of the first movable latching element, the receiving structure can be placed on the retaining structure (when attaching the flat item to the object) or lifted off the retaining structure (when detaching the flat item from the object). No mechanical actuation buttons are required to switch the retaining structure between its latched position and its release position.

When attaching the flat item, a first latching section of the first movable latching element engages behind a corresponding first receiving section of the receiving structure when the receiving structure is placed on the first movable latching element. In contrast, a second latching section of a second fixed latching element arranged opposite the first movable latching element does not engage behind a corresponding second receiving section of the receiving structure arranged opposite the first receiving section. Instead, the second fixed latching element or its second latching section is arranged outside the second receiving section. The direction in which the receiving structure is placed on the retaining structure is essentially transverse to the direction of movement of the movable first latching element. When the receiving structure is placed on the first movable latching element, the second fixed latching element cannot enter the receiving section, as the retaining structure is in its latching position, in which the latching elements are moved away from each other in opposite directions. A distance between the first and second latching sections is preferably greater than a clear width between the first and second receiving sections. For the aforementioned reasons, the receiving structure (together with the flat item) is placed obliquely on the retaining structure.

To this end, it is suggested that the receiving structure is designed such that it can be placed at an angle on the at least one first movable latching element, so that a first receiving section of the receiving structure engages behind the latching section of the at least one first movable latching element, whereas a second receiving section of the receiving structure is arranged in front of the latching section of the at least one other fixedly arranged latching element.

After placing the flat item on the first movable latching element, the user moves the flat item together with the receiving structure and the movable first latching element in the direction of movement of the movable first latching element, so that the latter is moved linearly from the extended position to the retracted position.

To this end, it is suggested that the retaining structure is designed such that, when the receiving structure is placed obliquely on the retaining structure, an application of force to the receiving structure in a direction that is substantially parallel to a direction of movement of the at least one first movable latching element moves the at least one first movable latching element into a retracted position.

The movement of the flat item together with the receiving structure from the extended position into the retracted position of the movable first latching element can take place against the force of a spring element. The spring element can be designed to move the first latching element into its extended position and hold it there.

In the retracted position of the first movable latching element, the retaining structure is in its release position and can be received up by the receiving structure. The user can now swivel or pivot the flat item together with the receiving structure attached to it or formed on it from the inclined position towards the retaining structure so that the fixed second latching element enters the receiving structure. A pivot axis of the pivoting movement extends in the region of the movable first latching element, in particular in the region of the first latching section, transversely to the direction of movement of the movable first latching element.

To this end, it is suggested that the receiving structure is designed in such a way that it can be pivoted from the inclined position towards the retaining structure when the at least one first movable latching element is in the retracted position.

The user, who is still gripping the flat item, can then move it together with the receiving structure and the movable first latching element in the opposite direction of movement of the movable first latching element, so that the latter is moved linearly from the retracted position to the extended position. In the process, the second latching section of the fixed second latching element engages with the corresponding second receiving section of the receiving structure. In particular, the second latching section then engages behind the second receiving section. The retaining structure is now back in its latching position. The flat item is held securely and reliably in respect to the retaining structure of the object through the receiving structure.

To this end, it is suggested that the retaining structure is designed in such a way that, once the receiving structure is pivoted in the direction of the retaining structure, the at least one first movable latching element moves together with the receiving structure into the extended position, wherein a second receiving section of the receiving structure, which is arranged opposite the first receiving section, engages behind the latching section of the at least one other fixedly arranged latching element.

The movement of the flat item together with the receiving structure from the retracted position into the extended position of the movable first latching element can be assisted by a spring element, and in some circumstances—if the spring element is sufficiently strong—can even be carried out automatically by the force of the spring element alone without any action on the part of the user.

The flat item or its receiving structure is released from the object or its retaining structure in the reverse order. The user grasps the flat item, pushes it together with the movable first latching element into the retracted position (linear movement in a first direction), pivots the flat item together with the receiving structure about the pivot axis away from the retaining structure (pivoting movement about the pivot axis) and then moves the flat item together with the first latching element into the extended position (linear movement in a second direction opposite to the first direction), in which the flat item or its receiving structure can be released and removed from the object or its retaining structure.

The above description assumes that the receiving structure is associated with the flat item and the retaining structure is associated with the object. Of course, it would also be conceivable that, in a simple kinematic reversal, the retaining structure with the latching elements movable in respect to each other, is assigned to the flat item and the receiving structure to the object.

The number of moving parts in the holding system can be significantly reduced by having only one movable latching element. This allows for a simpler, more cost-effective and more robust design of the holding system. In addition, the operation and use—as described above—is particularly simple and user-friendly. In particular, operation of the holding system is possible with one hand.

According to a preferred embodiment of the invention, it is suggested that the at least one first movable latching element is acted upon by means of a spring element and is held in an extended position so that the retaining structure is in the latching position. The spring element comprises at least one, preferably two compression springs, which are supported on the base body on the one hand and on the movable first latching element on the other hand. Preferably, the spring(s) of the spring element are helical springs. It would also be conceivable, for example, for them to be designed as stirrup or yoke springs.

The spring element should be strong enough to hold the movable first latching element in the extended position or the retaining structure in the latching position, depending on the design of the holding system, even with the receiving structure and even the flat item attached or formed thereon. In addition, magnets can be provided which act between the receiving structure and the retaining structure and apply an additional magnetic retaining force in order to additionally secure the movable first latching element and, depending on the design of the holding system even with the receiving structure and the flat item attached or formed thereon, in the extended position or the retaining structure in the latched position. Additional retaining forces for securing the retaining structure in the latched position can also be applied in ways other than magnetically.

Accordingly, it is suggested that the at least one first movable latching element can be acted upon manually against the force of a spring element in order to move the at least one first latching element into a retracted position so that the retaining structure is in the release position. Thus, in order to move the movable first latching element into the retracted position or the retaining structure into the release position, the spring force of the spring element and—if present—additional retaining forces, e.g., a magnetic retaining force, must be overcome.

Preferably, the flat item is a mobile electronic end user device, in particular a cell or a mobile phone, a smartphone, a tablet PC, a mobile navigation device, a photo camera or a display device.

Preferably, the receiving structure is associated with the flat item, preferably it is an integral part of the flat item or part of a cover or case for the flat item, which can be detachably attached to the flat item. In particular, it is envisaged that the receiving structure is arranged on a rear side of a cover or case for the mobile electronic end user device that faces outwards away from the mobile electronic end user device. It is conceivable that the receiving structure is formed separately from the cover or case and is attached to the back of the cover or case, for example by means of an adhesive layer. It would also be conceivable to attach it to the cover or case by clamping, shrinking, welding, soldering or other means. The receiving structure can also be attached directly to the flat item, again in one of the ways mentioned. In an alternative embodiment it would also be possible to associate the retaining structure to the flat item, in particular to a rear side of a cover or case for the flat item.

If the receiving structure is an integral part of the flat item, it can, for example, be incorporated into the housing of a mobile electronic end user device. Preferably, the receiving structure is an integral part of the cover or case for the mobile electronic end user device. The present invention thus also relates to protective covers or cases for mobile electronic end user devices, where on the external rear side of which the receiving structure of the holding system according to the invention is formed or arranged. The protective cover or case can detachably engage with a retaining structure of the holding system by means of the receiving structure in order to detachably fasten the mobile end user device held in the cover or case to the retaining structure.

Preferably, the object is a holding device which is designed for preferably detachable attachment to a component of a vehicle, in particular to a vehicle handlebar or steering rod or a vehicle dashboard, or for preferably detachable attachment to an item of furniture or for standing independently on a flat surface, or the object is a personal utensil of a user, in particular a purse, a handbag, a pocket calendar, a drawing board or a notepad. A holding device for independent standing can, for example, be designed as a stand or a so-called tripod. The item of furniture can be, for example, a shelf, a floor lamp, a table base, a cupboard door or similar. The design of the object as a personal utensil of the user has the advantage that, for example, a mobile electronic end user device and a purse or handbag can be joined together by the holding system according to the invention to form a detachable unit that is easier to handle.

The holding device preferably comprises a fastening device for preferably releasably fastening the holding device to a component of a vehicle, in particular to a vehicle handlebar or steering rod, a vehicle body or to a motor vehicle dashboard, in particular to slats of a heating or cooling air outlet in the dashboard, or for preferably releasably fastening the holding device to an item of furniture.

It is suggested that the retaining structure is associated with the object, preferably is an integral part of the object or part of a cover or case for the object, which can be detachably attached to the object. For example, it would be conceivable that a purse or a handbag has a retaining structure of the holding system according to the invention on one of its external surfaces, by means of which the purse or the handbag can be detachably attached to a receiving structure of a flat item.

A method according to the invention for releasably attaching a flat item to an object using the holding system according to the invention comprises the following method steps:
placing the receiving structure obliquely on at least one first movable latching element, so that a first receiving section of the receiving structure engages behind a latching section of at least one first movable latching element, whereas a second receiving section of the receiving structure is arranged in front of the latching section of at least one other fixedly arranged latching element, which is arranged opposite to the at least one first movable latching element,
with the receiving structure placed on the at least one first movable latching element, applying a force to the obliquely placed receiving structure in a direction which is substantially parallel to a direction of movement of the at least one first movable latching element, so that the at least one first movable latching element is moved by the receiving structure into a retracted position in which the retaining structure is in a release position,
with the at least one first movable latching element in the retracted position, pivoting the receiving structure from the inclined position in the direction towards the retaining structure, and
with the receiving structure pivoted in the direction towards the retaining structure, moving the at least one first movable latching element together with the receiving structure into an extended position in which the retaining structure is in a latching position, wherein a second receiving section of the receiving structure, which is arranged opposite the first receiving section, engages behind the latching section of the at least one other fixedly arranged latching element.

Further features and advantages of the present invention are explained in more detail below with reference to the figures. It is emphasized that individual features shown in the figures may also be essential to the invention on their own, even if this is not shown in the figures and not expressly mentioned in the description. Furthermore, the individual features shown in the figures can be combined with each other in any way desired, even if this combination is not shown in the figures and is not expressly mentioned in the description. The figures show

### BRIEF DESCRIPTION OF THE DRAWING

FIG. 1 a holding system according to the invention according to a first preferred embodiment in a perspective view with a holding device attached to a vehicle handlebar and a receiving structure attached to a retaining structure;

FIG. 2 the holding system of FIG. 1 without the receiving structure attached to the retaining structure;

FIG. 3 an exploded view of the holding system of FIG. 2;

FIG. 4 a receiving structure of a holding system according to the invention with a view of a side visible when the receiving structure is attached to a flat item;

FIG. 5 the receiving structure of FIG. 4 with a view of a side to be attached to the flat item;

FIGS. 6 to 10 different sectional views of a holding system according to the invention to illustrate different steps of a method according to the invention for releasably attaching a receiving structure of the holding system to a retaining structure of the holding system;

FIG. 11 a holding system according to the invention according to a further preferred embodiment in a sectional view with a holding device attached to a vehicle handlebar without a receiving structure;

FIG. 12 a perspective view of the holding system of FIG. 11 with the holding device attached to a vehicle handlebar and a receiving structure attached to a retaining structure;

FIG. 13 an enlarged view of parts of the holding system of FIG. 11 in the area of the retaining structure;

FIG. 14 a side view of the parts of the holding system in the area of the retaining structure from FIG. 13;

FIG. 15 a perspective view of the parts of the holding system in the area of the retaining structure from FIG. 13;

FIG. 16 an exploded view of the parts of the holding system in the area of the retaining structure from FIG. 13;

FIG. 17 a perspective view of a vibration decoupling unit as part of the holding system in the area of the retaining structure from FIG. 13; and

FIG. 18 a plan view of the retaining structure of the holding system of FIG. 13.

### DETAILED DESCRIPTION OF THE BEST MODE OF THE INVENTION

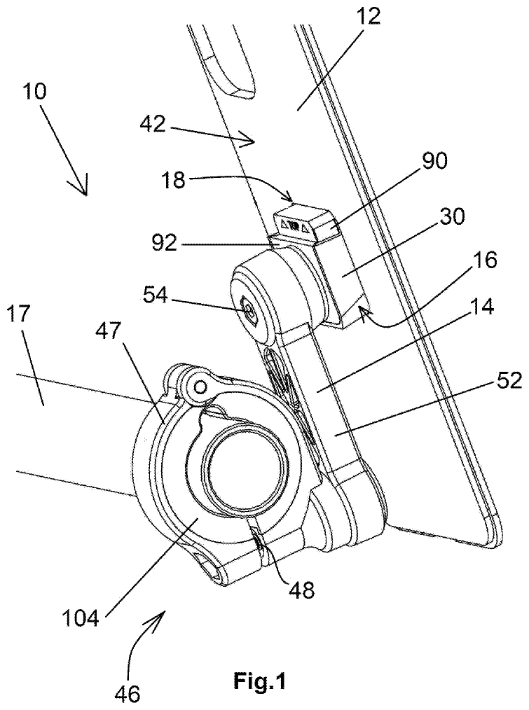

FIG. 1 shows a holding system 10 according to the invention for releasably attaching a flat item 12 to an object 14. In the example shown, the flat item 12 is designed as a cover or case of a mobile electronic end user device, for example a smartphone. However, it can also be designed as the mobile electronic end user device itself. Furthermore, the mobile electronic end user device 12 could also be a cell phone, a tablet PC, a mobile navigation device, a camera or a display device.

In the example shown, the object 14 is designed as a holding device, which is designed for preferably detachable attachment to a component of a vehicle, in particular to a vehicle handlebar 17. However, the holding device 14 could also be designed for preferably detachable attachment to a motor vehicle dashboard, in particular in slats of a cooling air or heating air opening in the dashboard. Furthermore, the holding device 14 could be designed for preferably detachable attachment to an item of furniture (e.g., a shelf, a floor lamp, a table base or a cupboard door) or for standing independently on a flat surface (e.g., tripod or stand). Finally, it would also be conceivable that the object 14 is a personal utensil of a user, in particular a purse, a handbag, a pocket calendar, a drawing board or a notepad.

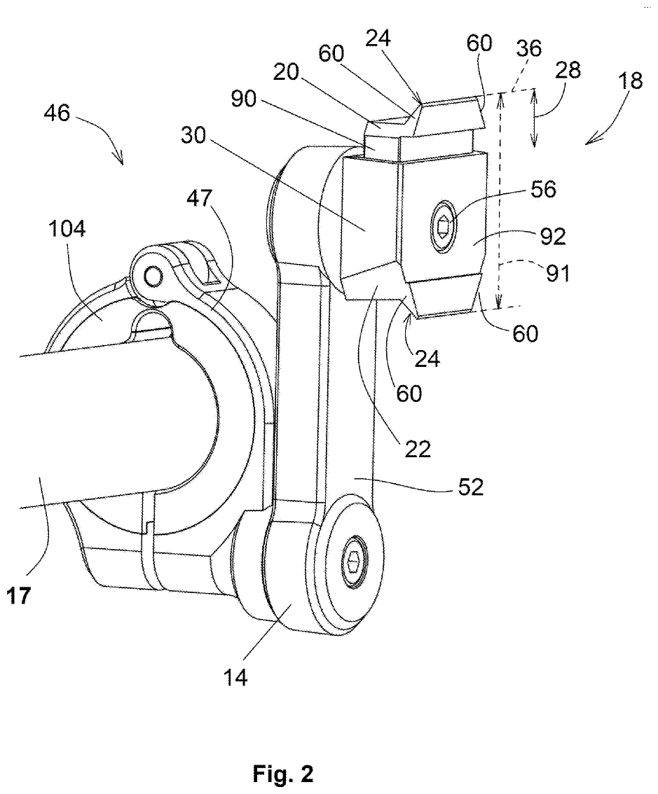

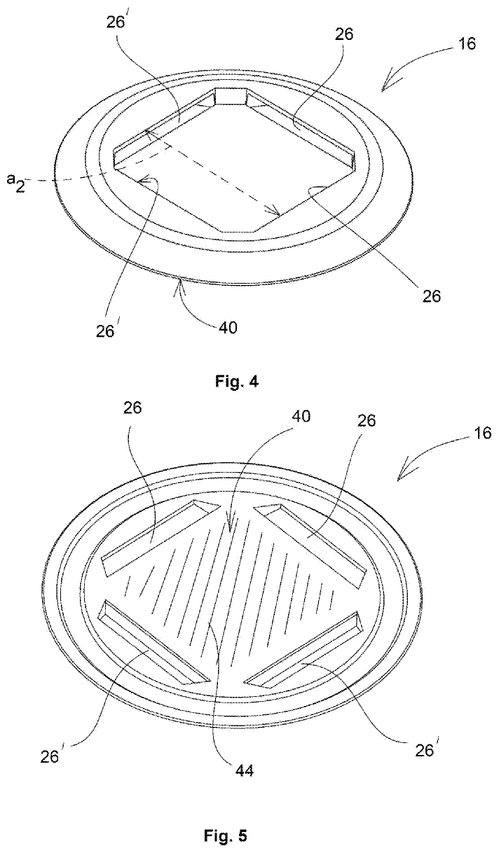

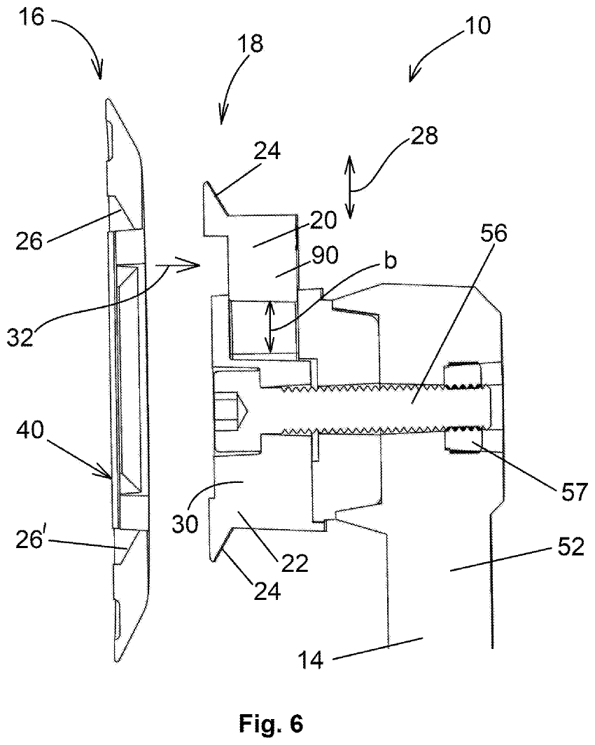

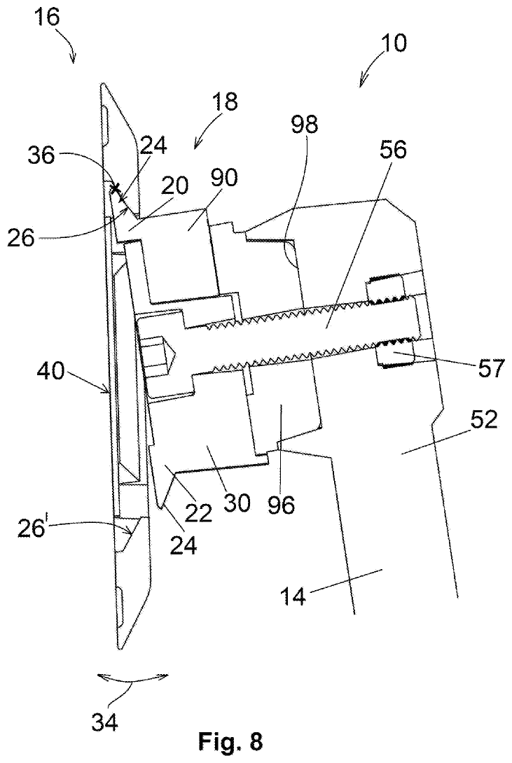

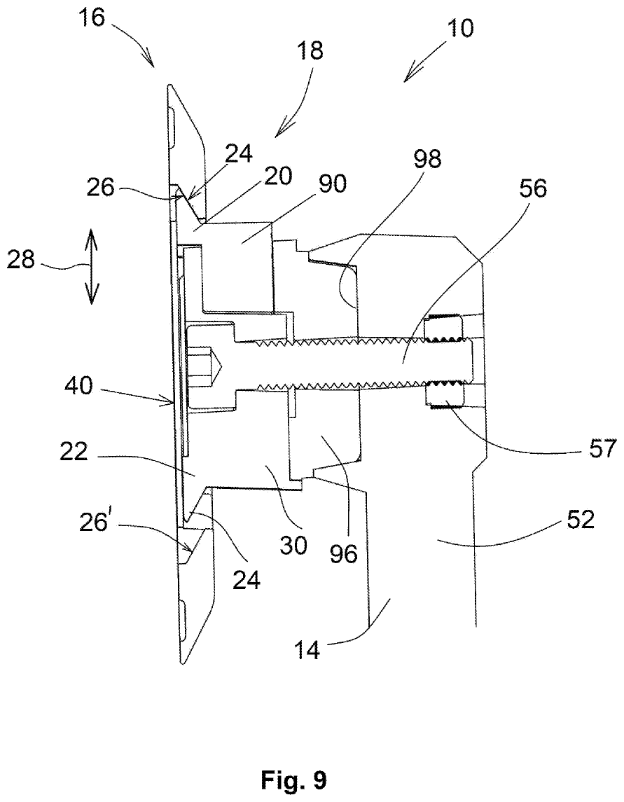

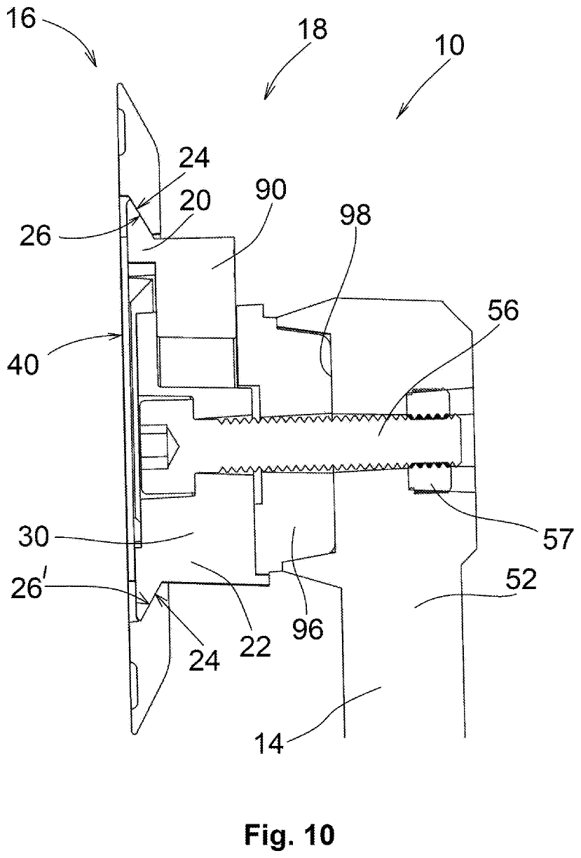

One of the two, flat item 12 or object 14, is assigned a receiving structure 16 (see FIGS. 4 and 5) and the other of the two is assigned a retaining structure 18 (see FIG. 2), which structures 16, 18 can engage with one another for releasable attachment of the flat item 12 to the object 14. As can be seen from FIG. 2, the retaining structure 18 has at least two latching elements 20, 22 which are arranged opposite one another and movable relative to one another and which have latching sections 24 which can engage with corresponding receiving sections 26 of the receiving structure 16. The oppositely arranged latching elements 20, 22 are movable relative to each other in a direction of movement 28 such that in a latching position of the retaining structure 18 (see FIGS. 6, 7 and 10) they are at a greater distance a1 (see FIG. 2) from each other than in a release position of the retaining structure 18 (see FIGS. 8 and 9). The retaining structure 18 can be inserted into or removed from the receiving structure 16 in the release position (cf. transition from FIG. 8 to FIG. 9) and can be latched to the receiving structure 16 in the latching position (cf. FIG. 10).

The present invention proposes a linear holding system 10 that is particularly easy and quick to operate and is particularly robust. This is achieved in particular by the fact that
the retaining structure 18 has a base body 30 and
only at least one first latching element 20 of the latching elements 20, 22 is movably guided in respect to the base body 30, whereas at least one other latching element 22 of the latching elements 20, 22 arranged opposite the at least one first movable latching element 20 is fixed immovably to the base body 30 or forms an integral part of the base body 30.

This can be seen very clearly in FIG. 2.

For better understanding, only a movable first latching element 20 and a fixed, immovable second latching element 22 are referred to below. However, it is understood that this always refers to at least one movable first latching element 20 and at least one fixed, immovable second latching element 22. Two or more movable first latching elements 20 are preferably located side by side and directions of their respective movement preferably extend in the same plane and parallel to each other.

Preferably, the first movable latching element 20 is guided linearly movably in respect to the base body 30 in the direction of movement 28 between an extended position (see FIGS. 6, 7 and 10), in which the retaining structure 18 is in the latching position, and a retracted position (see FIGS. 8 and 9), in which the retaining structure 18 is in the release position.

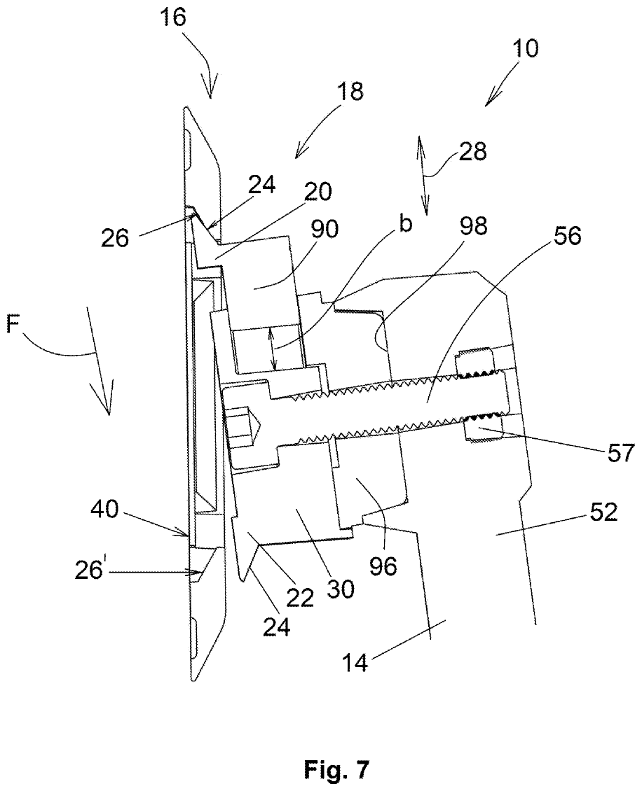

The movement path b (cf. FIG. 7) covered by moving the movable latching element 20 from an extended to a retracted position is such that the retaining structure 18 moves from the latching position to the release position, so that the retaining structure 18 or a part thereof can be inserted into the receiving structure 16 (cf. transition from FIG. 8 to FIG. 9).

In the invention, the movement of the movable first latching element 20 from the extended to the retracted position is effected in a particularly advantageous manner by the receiving structure 16 placed only on the movable latching element 20, in particular together with the flat item 12 attached thereto. Solely by gripping the flat item 12, a user can move it together with the receiving structure 16 and the movable latching element 20, on which the receiving structure 16 is placed, in the direction towards the retracted position (cf. transition from FIG. 7 to FIG. 8). In the retracted position of the first movable latching element 20, the receiving structure 16 can be placed on the retaining structure 18 (when attaching the flat item 12 to the object 14) or lifted off the retaining structure 18 (when detaching the flat item 12 from the object 14). No mechanical actuation buttons are required on the holding system 10 to bring the retaining structure 18 into its release position. In addition, operation (attaching and detaching the flat item 12 to the object 14) is easily possible with just one hand.

When attaching the flat item 12, a latching section 24 of the movable latching element 20 engages behind a corresponding receiving section 26 of the receiving structure 16 when the receiving structure 16 is placed on the movable latching element 20. In contrast, in this phase a latching section 24 of a fixed latching element 22 arranged opposite the movable latching element 20 does not yet engage behind a corresponding second receiving section 26′ of the receiving structure 16 arranged opposite the first receiving section 26 (see FIG. 7). Instead, the fixed latching element 22 or its latching section 24 is arranged outside or in front of the second receiving section 26′. A placement direction 32 of the receiving structure 16 on the retaining structure 18 initially runs essentially transverse to the direction of movement 28 of the movable first latching element 22 (see FIG. 6). Subsequently, the obliquely placed receiving structure 16 can be moved parallel to the direction of movement 28 of the movable latching element 20, in FIG. 7 downwards, so that the first receiving section 26 of the receiving structure 26 engages with the latching section 24 of the movable latching element 20 (cf. FIG. 7).

When the receiving structure 16 is placed on the first movable latching element 20, the second fixed latching element 22 cannot enter the second receiving section 26′ yet, since the retaining structure 18 is in its latching position, in which the latching elements 20, 22 are moved away from each other in opposite directions. The distance a1 between the latching sections 24 of the latching elements 20, 22 (see FIG. 2) is preferably greater than a clear width a2 between the first and second receiving sections 26, 26′ (see FIG. 4) of the receiving structure 16. For the reasons mentioned, the receiving structure 16 (together with the flat item 12) is placed at an angle or obliquely on the retaining structure 18 (see FIG. 7).

The receiving sections 26, 26′ have undercuts in the receiving structure 16. As can be seen from FIGS. 4 and 5, the receiving structure 16 preferably has four receiving sections 26, each arranged at an angle of 90° to one another, so that the receiving structure 16 together with the flat item 12 can be attached longitudinally or transversely to the object 14.

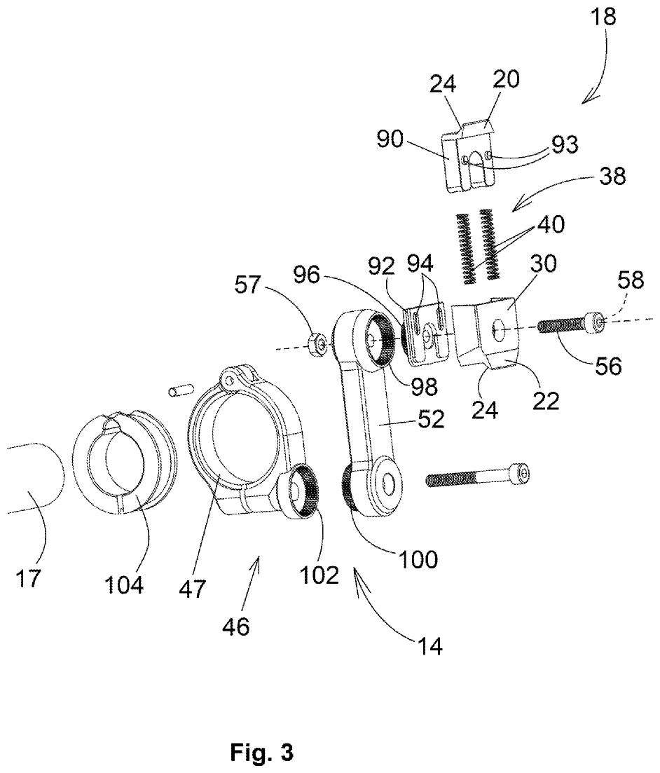

Preferably, the movable latching element 20 is acted upon by a spring element 38 and held in an extended position so that the retaining structure 18 is in the latching position (see FIG. 3). The spring element 38 comprises at least one, preferably two compression springs 40, which are supported on the base body 30 on the one hand and on the movable latching element 20 on the other. Preferably, the spring(s) 40 of the spring element 38 are helical springs. However, they could also be realized as another type of spring, e.g., as leaf springs or the like.

Only two opposing receiving sections 26, 26′ are ever required for detachable attachment of the flat item 12 to the object 14. The unused receiving sections 26, 26′ can form lateral guides and serve to further spatially define the position of the flat item 12 with respect to the holding system 10 and prevent undesired rotation or vibration of the item 12 (about an axis 58). The two opposing unused lateral receiving sections 26, 26′ can transmit a torque from the flat item 12 to the holding system 10, whereby the item 12 is also rotationally fixed (about the axis 58). The unused receiving sections 26, 26′ can provide lateral guidance of the received retaining structure 18, in particular during the linear movement of the movable latching element 20 relative to the base body 30, during which a relative movement between the base body 30 and the receiving structure 16 takes place.

After placing the receiving structure 16 together with the flat item 12 on the movable latching element 20, the user moves the flat item 12 together with the receiving structure 16 and the movable latching element 20 in the direction of movement 28, in the transition from FIG. 7 to FIG. 8 downwards, so that the movable latching element 20 is moved linearly from the extended position to the retracted position. In order to move the movable latching element 20 into the retracted position or the retaining structure 18 into the release position, the spring force of the spring element 38 and—if present—additional retaining forces must be overcome, which can hold the first latching element 20 in its extended position.

In the retracted position of the movable latching element 20 (see FIG. 8), the retaining structure 18 is in its release position and can be received by the receiving structure 16. Advantageously, not the entire retaining structure 18 is received, but only a part thereof, preferably only the latching sections 24 of the latching elements 20, 22. The user can now move the flat item 12 together with the receiving structure 16 attached to or formed thereon from the inclined position (cf. FIG. 8) in the direction towards the retaining structure 18 (counter clockwise pivoting movement 34), so that the fixed latching element 22 enters the receiving structure 16 and is positioned there in front of the second holding section 26′ (see FIG. 9). A pivot axis 36 of the pivoting movement 34 thereby extends in the region of the movable latching element 20, in particular in the region of the corresponding latching section 24, most preferably along a distal edge of the latching section 24, transverse to the direction of movement 28 of the movable latching element 20.

The user, who still grasps the flat item 12, can then move it together with the receiving structure 16 and the movable latching element 20 opposite to the direction of movement 28 of the movable latching element 20, i.e., upwards in the transition from FIG. 9 to FIG. 10, so that the latter returns from the retracted position to the extended position. This movement can be assisted or even carried out automatically (i.e., without the user having to hold or guide the flat item 12) by the spring force of the spring element 38. By doing so, the latching section 24 of the fixed latching element 22 engages with the corresponding second receiving section 26′ of the receiving structure 16 (see FIG. 10). In particular, the latching section 24 of the fixed latching element 22 then enters behind the second receiving section 26′. The retaining structure 18 is now back in its latching position. The flat item 12 is securely and reliably fastened to the retaining structure 18 of the object 14 via the receiving structure 16.

The flat item 12 or its receiving structure 16 is released from the object 14 or its retaining structure 18 in the reverse order. The user grasps the flat item 12, pushes it together with the movable latching element 20 into the retracted position (linear movement in a first direction 28; in FIGS. 6 to 10 downwards), pivots the flat item 12 together with the receiving structure 16 about the pivot axis 36 (clockwise pivoting movement 34) away from the retaining structure 18 and then moves the flat item 12, which is now oriented in an angle in respect to the retaining structure 18, together with the movable latching element 20 into the extended position (linear movement in a second direction 28, which is opposite to the first direction 28; in FIGS. 6 to 10 upwards), in which the flat item 12 or its receiving structure 16 can be released and removed from the object 14 or its retaining structure 18. The linear movement of the flat item 12 together with the movable latching element 20 into the extended position can be supported by a spring element 38 or, thanks to a spring element 38, can even be carried out automatically.

The above description assumes, by way of example, that the flat item 12 is assigned the receiving structure 16 and the object 14 is assigned the retaining structure 18. Of course, it would also be conceivable that, in a simple kinematic reversal, the retaining structure 18 is assigned to the flat item 12 and the receiving structure 16 is assigned to the object 14.

Furthermore, the above description assumes that the movable first latching element 20 is movable in a substantially vertical direction (direction of movement 28). Of course, it would also be conceivable for the first latching element 20 to be movable in a substantially horizontal direction (perpendicular to the direction of movement 28).

Furthermore, in the examples shown, the latching sections 24 are formed facing away from each other (pointing radially outwards) on the latching elements 20, 22. It would also be conceivable that the latching sections 24 are formed facing each other (pointing radially inwards) on the latching elements 20, 22. However, this would require a corresponding redesign of the receiving sections 26, 26′ of the receiving structure 16.

The number of movable parts of the holding system 10 can be significantly reduced by having only one movable latching element 20 and the fixed second latching element 22. A mechanism with actuation buttons for moving the retaining structure 18 into the release position can be dispensed with entirely. This allows a simpler, more cost-efficient and more robust design of the holding system 10. In addition, the operation—as described above—is particularly simple and user-friendly. In particular, operation and use of the holding system 10 with one hand and with gloves is easily possible in both horizontal and vertical directions of movement.

In the embodiments shown, the movable latching element 20 is arranged at the top of the retaining structure 18. The spring element 38 must therefore be selected to be at least strong enough so that the flat item 12 attached to the retaining structure 18 cannot already move the movable latching element 20 downwards into the retracted position and thus the retaining structure 18 into the release position by its own weight.

In a modification of the shown embodiment, it would also be conceivable for the movable first latching element 20 to be arranged at the bottom of the retaining structure 18, in which case the fixed latching element 22 would be arranged at the top. The flat item 12 attached to the retaining structure 18 would then not be supported on the movable latching element 20, but rather on the fixed latching element 22. The spring element 38 could be dimensioned correspondingly smaller, as it would only have to hold the movable latching element 20 in its extended position, which is also supported by the weight of the first latching element 20 itself.

In this case, the receiving structure 16 would then have to be placed on the movable latching element 20 at an angle from below, and the latching element 20 would have to be moved upwards in order to be able to bring the second receiving section 26′ into engagement with the latching section 24 of the upper fixed latching element 22.

Preferably, the receiving structure 16 is associated with the flat item 12. The receiving structure 16 may be an integral part of the flat item 12 or may be designed as a separate part and attached thereto, for example by means of an adhesive layer 44 on a side 40 to be attached to the flat item 12. In particular, the receiving structure 16 is arranged on a rear surface 42 of a protective cover or case 12 for the mobile electronic end user device, which rear surface 42 is directed outwards and away from the mobile electronic end user device. The present invention also relates to protective covers or cases 12 for mobile electronic end user devices, on the outer rear surface 42 of which the receiving structure 16 of the holding system 10 according to the invention is formed or arranged. By means of the receiving structure 16, the protective cover or case 12 can releasably engage with a retaining structure 18 of the holding system 10 in order to releasably fasten the mobile end user device received in the cover or case 12 to the retaining structure 18 or to the object 14, respectively.

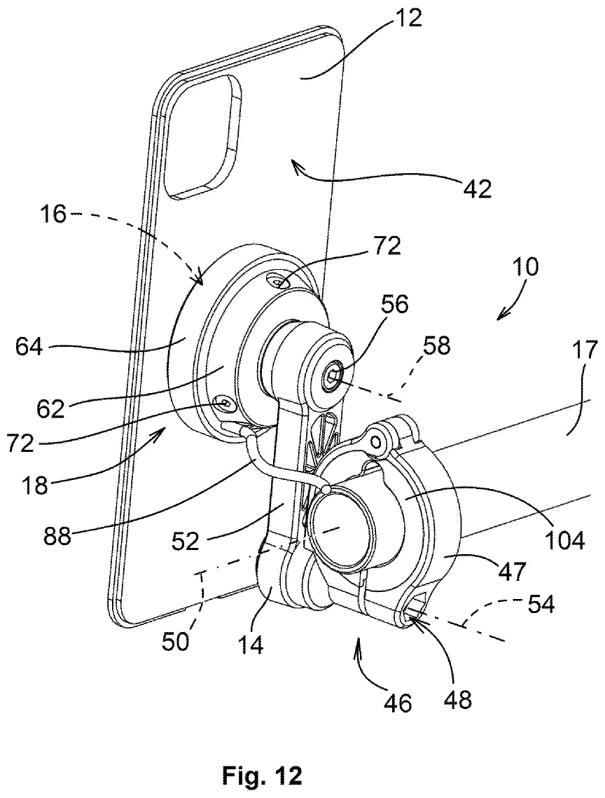

According to FIG. 12, the holding device 14 can have a fastening device 46 for preferably releasably fastening the holding device 14 to a component of a vehicle, in particular to a vehicle handlebar 17. In the example shown, the fastening device 46 comprises a clamp 47, which can be fixed to the handlebar 17 in a desired rotational position about a longitudinal axis 50 extending along the handlebar 17 by means of a screw 48. Furthermore, a fastening arm 52 can be fastened to the fastening device 46 in a desired rotational position about a rotational axis 54 by means of the screw 48. Another screw 56 can be used to fasten the retaining structure 18 to the fastening arm 52 in a desired rotational position about a further axis of rotation 58. Thus, the holding device 14 can be used to realize a mounting of the retaining structure 18 on the vehicle handlebar 17 that is adjustable in several degrees of freedom and thus also a mounting in any desired arrangement and orientation of a mobile electrical end user device on a handlebar 17.

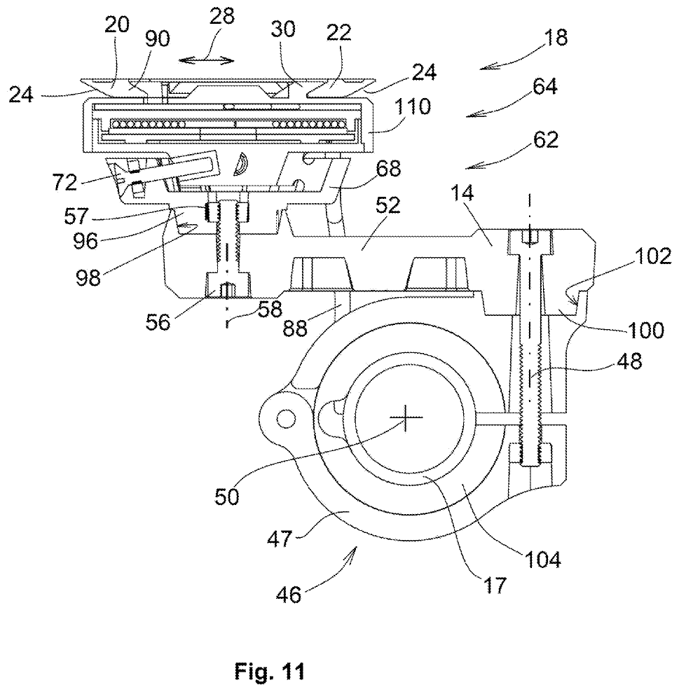

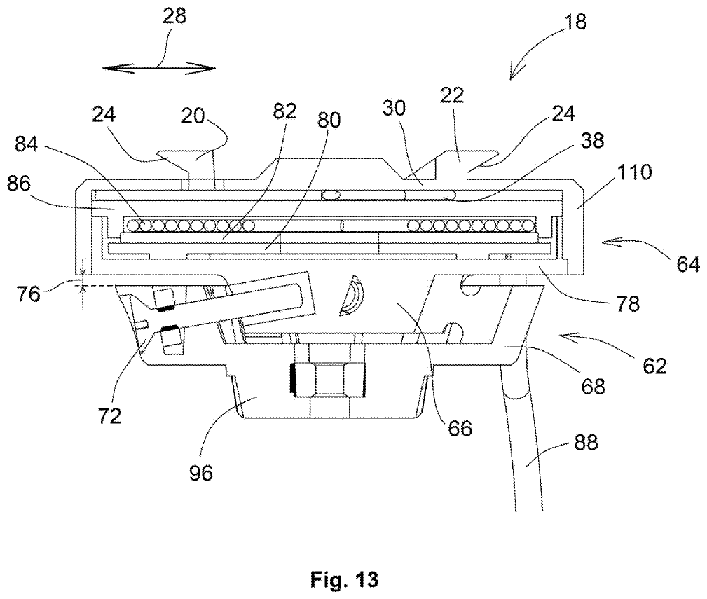

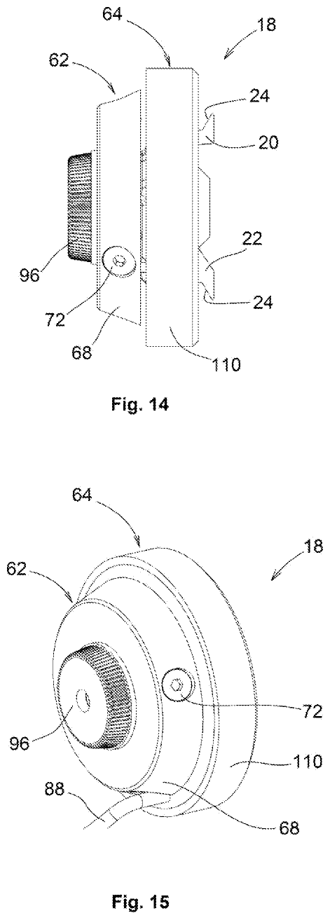

The holding system 10 according to the second embodiment of FIGS. 11-18 also has a vibration decoupling unit 62 and an inductive charging unit 64, which are shown in detail in FIG. 13.

The decoupling unit 62 serves to keep a structure-borne sound (or vibration) of the vehicle during its use away from the protective cover or case 12 and ultimately from the mobile electrical end user device accommodated therein. Without the decoupling unit 62, the structure-borne noise could cause damage to highly sensitive lens mountings and optics and other components of mobile electrical end user devices due to vibrations of the vehicle during use, in particular of the vehicle engine. The decoupling unit 62 ensures a floating mounting of the receiving structure 16 on the holding device 14.

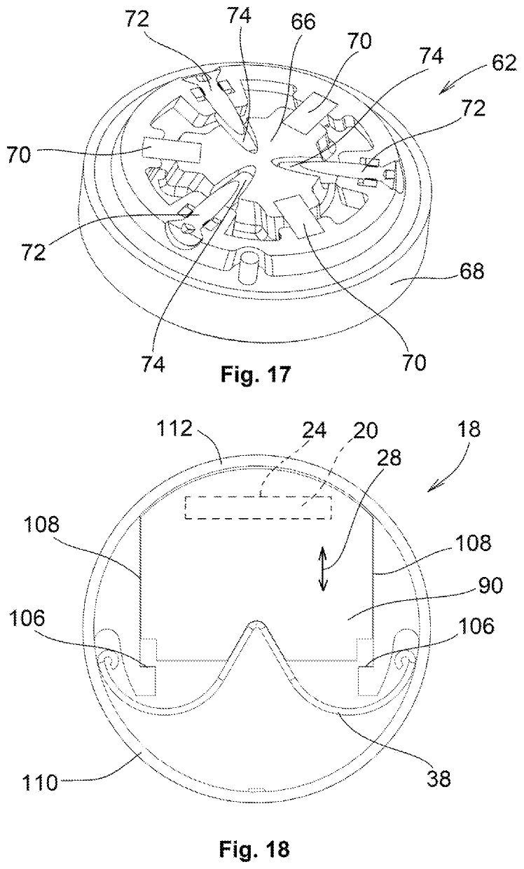

The floating mounting is shown in detail in FIG. 17. The vibration decoupling unit 62 comprises an outer peripheral region 68, which at the same time forms a housing of the decoupling unit 62. Of course, the peripheral region 68 and the housing could also be designed as separate parts and attached to each other. The outer peripheral region 68 is associated with the holding device 14 and is detachably fastened thereto by means of the screw 56. Furthermore, the decoupling unit 62 comprises a central region 66 floatingly mounted in the peripheral region 68, which is associated with the retaining structure 18 or is attached thereto via the inductive charging unit 64. Of course, it would also be conceivable to assign the peripheral region 68 to the retaining structure 18 and to assign the central region 66 to the holding device 14.

The two regions 66, 68 are spaced apart from one another through a gap extending in the circumferential direction and are connected to one another by means of a plurality of elastic elements 70. The elastic elements 70 are evenly distributed over the circumference of the gap and spaced apart from one another. In the example shown, three elastic elements 70 are provided, each at a distance of 120° from the neighbouring elements 70. However, it would also be conceivable to provide more or less than the three elements 70. The central region 66 is held exclusively by the elastic elements 70. The elements 70 ensure decoupling of the central region 66 from the peripheral region 68.

Furthermore, the decoupling unit 62 has limiting screws 72 which can limit one or more spatial degrees of freedom of movement of the floatingly suspended central region 66 relative to the peripheral region 68. The screws 72 are screwed into the circumferential region 68 and project into recesses 74, which are formed in the central region 66. Depending on the size and dimensions of the recesses 74 and how far the screws 72 are screwed in, the limitation of the spatial degrees of freedom can be set to desired v values. In the example shown, three limiting screws 72 are provided. However, it would also be conceivable to provide more or less than the three screws 72 or to dispense with them altogether. In the example, the screws 72 are arranged between the elastic elements 70. However, it would also be conceivable to arrange the limiting screws 72 elsewhere. A gap 76 is provided between the decoupling unit 62 and adjacent components, in this example the inductive charging unit 64, to allow free movement of the central region 60 relative to the peripheral region 68 as part of the vibration damping (see FIG. 13)

The inductive charging unit 64 is explained in more detail with reference to FIG. 13. It is used to inductively charge an appropriately equipped mobile electrical end user device. It comprises a housing component 78 and, arranged therein, a circuit board 80, a shield 82 and an induction coil 84. The housing 78 can be an integral part of the central region 66 of the decoupling unit 62. A cover 86 closes the housing component 78, preferably in a watertight manner. In particular, the cover 86 is bonded to the housing component 78. The interior of the housing component 78 can be filled with a resin or plastic or the like after the electrical components have been mounted therein and electrically contacted. A cable 88 is led into the housing component 78 in order to supply the induction coil 84 with electrical energy, for example from a portable battery or a so-called power bank. It would also be conceivable if the cable 88 were connected to a vehicle electrical system and drew the required energy for the induction coil 84 from the vehicle electrical system, e.g., from a vehicle battery. A housing 110 can be attached to the housing component 78, which housing 110 forms the base body 30 of the retaining structure 18. The fixed latching element 22 may be an integral part of the housing 110.

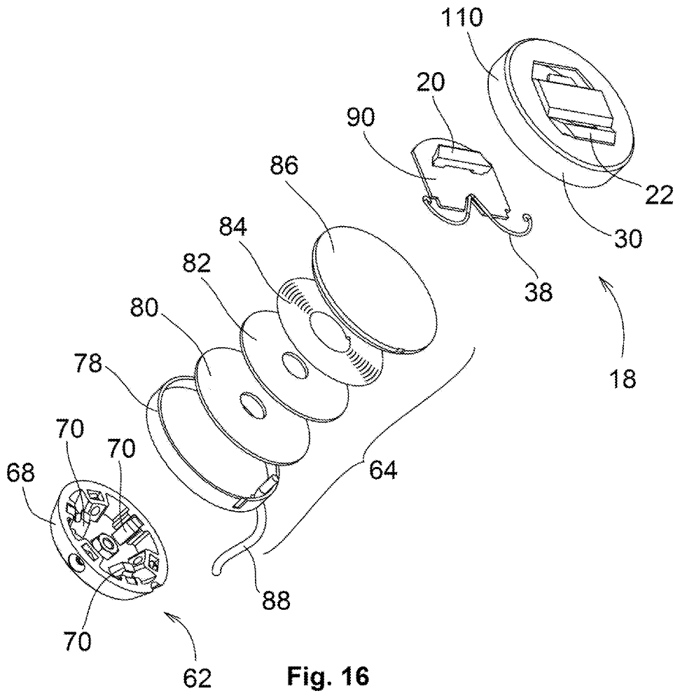

The individual components of the inductive charging unit 64 are also shown in the exploded view according to FIG. 16. It is conceivable that the cover 86 of the charging unit 64 and a slider 90, which carries the movable first latching element 20, are made of a plastic material, in particular a transparent plastic material. This allows a semiconductor light source, for example an LED, in particular an RGB LED, to be arranged in the watertight sealed housing component 78 and operated depending on an operating state of the inductive charging unit 64. The light emitted by the semiconductor light source can be coupled into the transparent slider 90 via the transparent cover 86, from which the light is then decoupled, for example, via the movable first latching element 20 so as to be visible from the outside by a user of the holding system 10. In this way, it would be conceivable to visually display status information about a current charging process to a user. For example, if the charging unit 64 is switched on and ready for operation, a green light could be emitted. If the charging unit 64 is switched off or not ready, for example, no light could be emitted. If a charging process is active, a blue light could be emitted. A defect in the charging unit 64 or an error in the charging process could, for example, be indicated by a red light.

A further particular feature of the holding system 10 according to the invention is that, unlike in the prior art, when the latching elements 20, 22 are engaged with the corresponding receiving sections 26, 26′ of the receiving structure 16, not the entire retaining structure 18 is received in the receiving structure 16. As can be clearly seen from FIG. 2, the latching sections 24 of the latching elements 20, 22 preferably project in the direction of the receiving structure 16 (i.e., away from the holding device 14) beyond the rest of the retaining structure 18, in particular beyond the base body 30, so that only the latching sections 24 are received in the receiving structure 16. This enables safe and reliable operation of the holding system 10 and attachment of the flat item 12 to the object 14 even if the retaining structure 18 or the receiving structure 16 is dirty.

FIG. 2 also shows that the side surfaces 60 of the latching elements 20, 22 are somewhat beveled in the region of the latching sections 24, so that the transverse surfaces, which are part of the latching sections 24, have a conical shape that tapers towards the distal ends of the latching elements 20, 22 and latching sections 24, respectively. In other words, the lateral surfaces 60 converge towards the distal ends. This facilitates the insertion of the movable first latching element 20 or its latching section 24 into the corresponding receiving section 26 of the receiving structure 16, and further improves the operability of the holding system 10. The distal ends of the latching sections 24 can have a rounded or chamfered cross-section in order to facilitate the pivoting of the receiving structure 16 about the pivot axis 36 (pivoting movement 34; see FIG. 8).

In the example of FIGS. 1-3, the base body 30 is hollow and open on two sides. The slider 90 with the movable first latching element 20 attached or formed thereon and the compression springs 40 are inserted into the base body 30 via the open upper side. A cover 92 is then fastened to the base body 30 by means of the screw 56, wherein guide pins 93 formed on the slider 90 engage in corresponding guide grooves 94 formed on an inner side of the cover 92 and the base body 30. Since the cover 92 is rigidly connected to the base body 30, it can be regarded as a part of the base body 30. Furthermore, the screw 56 serves to fasten the base body 30 to the holding device 14 or the fastening arm 52 so that it cannot rotate about the axis 58. In particular, the base body 30, the cover 92 and the fastening arm 52 are clamped between a screw head of the screw 56 and a nut 57. Although the slider in the example of FIGS. 1-3 is designed differently from the slider in the example of FIGS. 11-18, both sliders have been designated with the reference sign 90.

The non-rotatable fastening about the axis 58 is achieved by the fact that a conical projection 96 formed on the cover 92 has a knurling on its outer circumferential surface, which cooperates with a corresponding knurling of a correspondingly conically shaped recess 98 formed in the fastening arm 52. A rotationally fixed connection between the fastening arm 52 and the fastening device 46 is also achieved in a corresponding manner. There, a conical projection 100 is arranged on the fastening arm 52 with a knurling on its outer circumferential surface, which cooperates with a corresponding knurling of a correspondingly conically shaped recess 102, which is formed in the fastening device 46. By means of an adapter sleeve 104, which is preferably made of an elastic material, particularly preferably with a high coefficient of friction, the fastening device 46 can be adapted to handlebars 17 with different diameters.

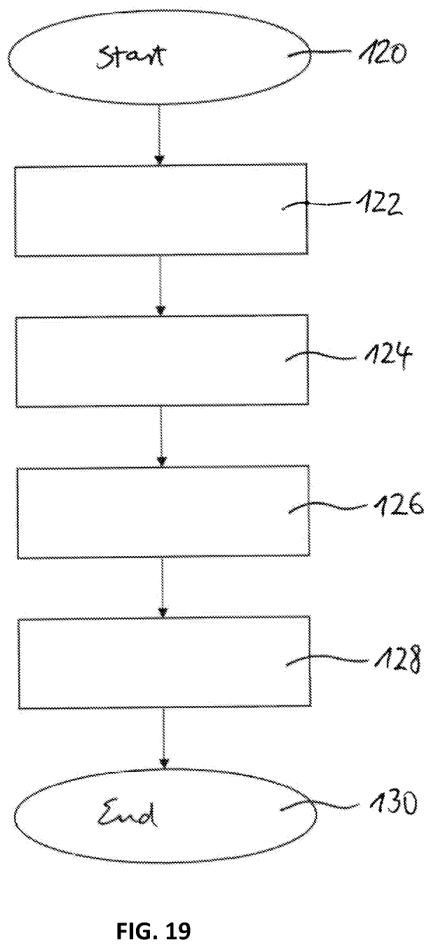

In the second embodiment according to FIGS. 11-18, the spring element 38 is designed as a U-bolt or bow compression spring (see FIGS. 16 and 18). In FIG. 18, stops 106 are also shown, which are attached to the base body 30 or are formed integrally therewith and cause a travel limitation for the slider 90 and thus for the movement of the movable first latching element 20 into the retracted position. The bow spring 38 presses the slider 90 and thus the movable first latching element 20 into the extended position. The slider 90 is guided in its linear movement by lateral guides 108, which are attached to the base body 30 or are formed integrally therewith. An inner side of an outer wall 112 of the housing 110 provides a path limitation for the slider 90 or for the movable first latching element 20 in the direction of the extended position. In the view of FIG. 18, the movable latching element 20 is formed on the rear side of the slider 90 and is shown in the extended position.

Finally, the method according to the invention for releasably attaching a flat item 12 to an object 14 using the holding system 10 according to the invention is explained in more detail with reference to FIG. 19. The method begins in a method step 120.

Then, in a first step 122, the receiving structure 16 is placed obliquely on the movable latching element 20 (transition from FIG. 6 to FIG. 7), with the movable latching element 20 being in an extracted position, so that a first receiving section 26 of the receiving structure 16 engages behind a latching section 24 of the movable latching element 20, whereas a second receiving section 26′ of the receiving structure 16 is arranged in front of the latching section 24 of the fixedly arranged latching element 22, which is arranged opposite to the movable latching element 20.

In a subsequent step 124, with the receiving structure 16 placed on the movable latching element 20, a force F is applied to the obliquely placed receiving structure 16 (see FIG. 7) in a direction which is substantially parallel to the direction of movement 28 of the movable latching element 20, so that the movable latching element 20 is moved by the receiving structure 16 from its extracted position into a retracted position (see FIG. 8), in which the retaining structure 18 is in a release position.

In a subsequent step 126, with the movable latching element 20 in the retracted position (see FIG. 8), the receiving structure 16 is pivoted from the inclined position towards the retaining structure 18 (see FIG. 9). The corresponding pivoting movement 34 about the pivot axis 36 is shown in FIG. 8.

Finally, in a step 128, with the receiving structure 16 pivoted towards the retaining structure 18 (see FIG. 9), the movable latching element 20 is moved together with the receiving structure 16 into the extended position, in which the retaining structure 18 returns in the latching position (see FIG. 10), wherein a second receiving section 26′ of the receiving structure 16, which is arranged opposite the first receiving section 26, engages behind the latching section 24 of the fixedly arranged latching element 22.

The flat item 12, which comprises the receiving structure 16, is thus attached to the object 14 and the method can be terminated in a method step 130. To release the flat item 12 from the object 14, the method steps 120 to 130 can be executed in reverse order.

In summary, the following advantageous basic principle of the invention according to a preferred embodiment can be noted: The proposed locking concept comprises two wedge-shaped latching elements 20, 22 on the side of the holding device 14, which are engaged in an undercut 26, 26′ in the receiving structure 16 of respective size and shape on the end user device side. One wedge-shaped element 20 is linearly movable and the other wedge-shaped element 22 is fixed. For locking, the end device is placed (hooked) with its receiving structure 16 on the movable latching element 20. The device now hangs loosely on the holding system 10, wherein the latching section 24 or the first movable latching element 20 engages in a first undercut 26 of the receiving structure 16. The user then pulls the end user device downwards and swivels it over the fixed latching element 22. When the end user device is released, the movable latching element 20 is pushed upwards, possibly by the spring element 38, whereby the latching section 24 of the fixed element 22 engages in the corresponding second undercut 26′. The locking geometry is now free of play and cannot be released by itself.

To separate the end user device from the holding system 10 again, the procedure is reversed. The user pushes the end user device downwards against the spring force of the spring element 38 and thus also moves the wedge-shaped locking element 20 downwards, whereby the latching section 24 of the fixed element 22 releases engagement with the corresponding second undercut 26′. Then, the end user device can be unhooked by a slight pivoting movement about the pivot axis 36 and removed from the holding system 10 by an upwards movement, thereby releasing engagement between the latching section 24 of the movable element 20 and the first undercut 26.

The holding system 10 according to the invention combines a linear and a rotational principle, is very space-saving and is accompanied by minimal user interaction. The holding system 10 consists of only very few parts and can be manufactured very inexpensively, for example by plastic injection molding. In particular, the slider 90 and/or the movable latching element 20 can be made of plastic. However, the base body 30 and/or the fixed latching element 22 can also be made of plastic. It is also conceivable to manufacture these components (90, 20; 30, 22) from several components, e.g., a core made of metal and at least partial overmolding of the metal core with plastic. The holding system 10 is particularly flat. The distance between the holding system 10 or the retaining structure 18 and the end user device is reduced to such an extent that inductive energy transmission is possible. By selecting a double-sided, wedge-shaped engagement geometry (latching elements 20, 22 with inclined side surfaces 60), on the one hand the latching connection is free of play and on the other hand centering is achieved when the latching section 24 of the movable latching element 20 first contacts the receiving structure 16 on the device.

1. Holding system (10) for releasable attachment of a flat item (12) to an object (14), wherein a receiving structure (16) is associated with one of the flat item (12) and the object (14) and a retaining structure (18) is associated with the other one of the two, and the two structures (16, 18) are designed to engage with one another for releasably attaching the flat item (12) to the object (14),
wherein the retaining structure (18) comprises at least two latching elements (20, 22) which are arranged opposite one another and movable relative to one another and which have latching sections (24) which are designed to engage with corresponding receiving sections (26; 26′) of the receiving structure (16), and the latching elements (20, 22) arranged opposite one another and movable relative to one another are movable relative to one another in such a way that a distance (a1) between the latching sections (24) can be varied, in order to switch the retaining structure (18) between a release position, in which the retaining structure (18) can be inserted into or removed from the receiving structure (16), and a latching position, in which the retaining structure (18) is latched to the receiving structure (16),
wherein the retaining structure (18) has a base body (30) and
only at least one first latching element (20) of the latching elements (20, 22) is movably guided in respect to the base body (30), whereas at least one other latching element (22) of the latching elements (20, 22) arranged opposite the at least one first movable latching element (20) is fixed immovably to the base body (30) or forms an integral part of the base body (30).

2. Holding system (10) according to claim 1, wherein the at least one first movable latching element (20) is guided linearly movably in respect to the base body (30) between an extended position, in which the retaining structure (18) is in the latching position, and a retracted position, in which the retaining structure (18) is in the release position.

3. Holding system (10) according to claim 1, wherein the at least one first movable latching element (20) is acted upon and held in an extended position by means of a spring element (38), so that the retaining structure (18) is in the latching position.

4. Holding system (10) according to claim 1, wherein the at least one first movable latching element (20) can be acted upon manually against the force of a spring element (38) in order to move the at least one first movable latching element (20) into a retracted position, so that the retaining structure (18) is in the release position.

5. Holding system (10) according to claim 1, wherein the receiving structure (16) is designed such that it can be placed obliquely on the at least one first movable latching element (20), so that a first receiving section (26) of the receiving structure (16) engages behind the latching section (24) of the at least one first movable latching element (20), whereas the latching section (24) of the at least one other fixedly arranged latching element (22) is arranged outside a second receiving section (26′) of the receiving structure (16), which second receiving section (26′) is arranged opposite the first receiving section (26).

6. Holding system (10) according to claim 5, wherein the retaining structure (18) is designed in such a way that, when the receiving structure (16) is placed obliquely on the retaining structure (18), an application of force to the receiving structure (16) in a direction which runs essentially parallel to a direction of movement (28) of the at least one first movable latching element (20) moves the at least one first movable latching element (20) into a retracted position.

7. Holding system (10) according to claim 6, wherein the receiving structure (16) is designed in such a way that it can be pivoted from the inclined position towards the retaining structure (18) when the at least one first movable latching element (20) is in the retracted position.

8. Holding system (10) according to claim 7, wherein the retaining structure (18) is designed such that, when the receiving structure (16) is pivoted towards the retaining structure (18), the at least one first movable latching element (20) moves together with the receiving structure (16) into the extended position, wherein the second receiving section (26′) of the receiving structure (16), which is arranged opposite the first receiving section (26), engages behind the latching section (24) of the at least one other fixedly arranged latching element (22).

9. Holding system (10) according to claim 1, wherein the flat item (12) is a mobile electronic end user device, including a mobile telephone, a smartphone, a tablet PC, a mobile navigation device, a camera or a display device, or is a protective cover or case for such a mobile electronic end user device.

10. Holding system (10) according to claim 1, wherein the receiving structure (16) is associated with the flat item (12), including where the receiving structure (16) is an integral part of the flat item (12) or is attached thereto.

11. Holding system (10) according to claim 9, wherein the receiving structure (16) is associated with the flat item (12), including where the receiving structure (16) is an integral part of the flat item (12) or is attached thereto.

12. Holding system (10) according to claim 1, wherein the object (14) is a holding device which is designed for detachable attachment to a component of a vehicle, including to a handlebar (17) of the vehicle, or to a motor vehicle dashboard or to an item of furniture or which is designed to stand independently on a flat surface, or is a personal utensil of a user, including a purse, a handbag, a pocket calendar, a drawing board or a notepad.

13. Holding system (10) according to claim 1, wherein the retaining structure (18) is associated with the object (14), including where the retaining structure (18) is an integral part of the object (14) or is attached to the object (14).

14. Holding system (10) according to claim 12, wherein the retaining structure (18) is associated with the object (14), including where the retaining structure (18) is an integral part of the object (14) or is attached to the object (14).

15. Holding device (14) for use in a holding system (10) according to claim 1, wherein the holding device (14) is an object to which a flat item (12) can be releasably attached, the holding device (14) comprising a retaining structure (18) which can engage with a receiving structure (16) associated with the flat item (12) for releasable attachment thereto,
wherein the retaining structure (18) comprises at least two latching elements (20, 22) which are arranged opposite one another and movable relative to one another and which have latching sections (24) which are designed to engage with corresponding receiving sections (26; 26′) of the receiving structure (16), and the latching elements (20, 22) arranged opposite one another are movable relative to one another in such a way that a distance (a1) between the latching sections (24) can be varied, in order to switch the retaining structure (18) between a release position, in which the retaining structure (18) can be inserted into or removed from the receiving structure (16), and a latching position, in which the retaining structure (18) is latched to the receiving structure (16),
wherein the retaining structure (18) has a base body (30) and
only at least one first latching element (20) of the latching elements (20, 22) is movably guided in respect to the base body (30), whereas at least one other latching element (22) of the latching elements (20, 22) arranged opposite the at least one first movable latching element (20) is fixed immovably to the base body (30) or forms an integral part of the base body (30).

16. Holding device (14) according to claim 15, wherein the holding device (14) has a fastening device (46) for releasably fastening the holding device (14) to a component of a vehicle, including to a handlebar (17) of the vehicle or to a motor vehicle dashboard, or for releasably fastening the holding device (14) to an item of furniture.

17. Protective cover or case (12) for a mobile electronic end user device, which protective cover or case (12) is designed to releasably receive the mobile electronic end user device in a manner protected from action of external force, the cover or case (12) being designed for use with a holding system (10) according to claim 1 and the cover or case (12) having an external rear surface (42) comprising a receiving structure (16) of the holding system (10), which receiving structure (16) is designed to engage with a retaining structure (18) of the holding system (10) in order to releasably fasten the mobile electronic end user device received in the cover or case (12) to a holding device (14) of the holding system (10).

18. Method for releasably attaching a flat item (12) to an object (14), wherein a receiving structure (16) is associated with one of the flat item (12) or the object (14) and a retaining structure (18) is associated with the other of the two, which structures (16, 18) can engage with each other for releasably attaching the flat item (12) to the object (14),
wherein the retaining structure (18) comprises at least two latching elements (20, 22) which are arranged opposite one another and movable relative to one another and which have latching sections (24) which are designed to engage with corresponding receiving sections (26; 26′) of the receiving structure (16), and the latching elements (20, 22) arranged opposite one another and movable relative to one another are movable relative to one another in such a way that a distance (a1) between the latching sections (24) can be varied, in order to switch the retaining structure (18) between a release position, in which the retaining structure (18) can be inserted into or removed from the receiving structure (16), and a latching position, in which the retaining structure (18) can be latched to the receiving structure (16), the method comprising the following steps:
placing the receiving structure (16) obliquely on at least one first movable latching element (20), so that a first receiving section (26) of the receiving structure (16) engages behind a latching section (24) of the at least one first movable latching element (20), whereas a second receiving section (26′) of the receiving structure (16), which is arranged opposite the first receiving section (26), is arranged in front of the latching section (24) of at least one other fixedly arranged latching element (22), which is arranged opposite the at least one first movable latching element (20),
with the receiving structure (16) obliquely placed on the at least one first movable latching element (20), applying a force to the obliquely placed receiving structure (16) in a direction which runs essentially parallel to a direction of movement (28) of the at least one first movable latching element (20), so that the at least one first movable latching element (20) is moved by the receiving structure (16) into a retracted position in which the retaining structure (18) is in a release position,
with the at least one first movable latching element (20) in the retracted position, pivoting the receiving structure (16) from the inclined position towards the retaining structure (18), and
with the receiving structure (16) pivoted towards the retaining structure (18), moving the at least one first movable latching element (20) together with the receiving structure (16) into an extended position in which the retaining structure (18) is in a latching position, wherein the second receiving section (26′) of the receiving structure (16) engages behind the latching section (24) of the at least one other fixedly arranged latching element (22).
